(19) United States
(12) Patent Application Publication
(10) Pub. No.: US 2025/0391594 A1
(43) Pub. Date: Dec. 25, 2025

(54) SAMARIUM COBALT MAGNET RECYCLING

(71) Applicant: ROLLS-ROYCE plc, London (GB)

(72) Inventors: James Thomas GRIFFITHS, Derby (GB); Oliver Peter BROOKS, Derby (GB); Richard Stuart SHERIDAN, Derby (GB); Alexis LAMBOURNE, Derby (GB)

(73) Assignee: ROLLS-ROYCE plc, London (GB)

(21) Appl. No.: 19/240,998

(22) Filed: Jun. 17, 2025

(30) Foreign Application Priority Data
Jun. 19, 2024 (GB) 2408808.0

(51) Int. Cl. H01F 1/055; C22B 7/00; C22B 59/00

(52) U.S. Cl. CPC H01F 1/0553; C22B 7/001; C22B 59/00; H01F 1/0556; H01F 1/0557

(57) ABSTRACT

The present disclosure relates to a method for recovering magnet material from a samarium cobalt, SmCo, magnet, the method comprising: initiating a hydrogen decrepitation process within a reaction vessel, wherein the hydrogen decrepitation process comprises: increasing a concentration of hydrogen in the reaction vessel, and maintaining the reaction vessel at either: a temperature of less than 70° C. and at a pressure of more than 10 bar, or at a temperature of more than 70° C. and at a pressure of less than 5 bar, to cause hydrogen decrepitation of the SmCo magnet disposed in the reaction vessel and produce SmCo-hydride material; and initiating a degasification process within a degasification vessel, wherein the degasification process comprises: removing gas from the degasification vessel and maintaining the degasification vessel at a temperature within a range of 150° C. to 300° C., to de-gas SmCo-hydride material disposed in the degasification vessel and produce SmCo material.

### BACKGROUND

This disclosure claims the benefit of UK Patent Application No. GB 2408808.0 filed on 19 Jun. 2024, which is hereby incorporated herein in its entirety.

### FIELD OF THE DISCLOSURE

This disclosure relates to a method and apparatus for recovering magnet material from a samarium cobalt magnet.

### BACKGROUND OF THE DISCLOSURE

At the end of life of a rare earth magnet, such as a samarium cobalt magnet, there may be a magnet material recovery process to reclaim at least some of the rare earth material present in the magnet. Typical magnet material recovery processes include thermal recycling of magnets by melting, or chemical recycling of magnets by wet-chemical (acid or other chemical) digestion. Such processes enable rare earth material present in the magnet to be reclaimed in a raw form. Multiple energy intensive processes are required to manufacture a rare earth magnet from such a raw form. For example, it may be required to: i) melt reclaimed material from the raw form to a molten alloy, ii) cast the molten alloy into moulds to form ingots, iii) pulverise (e.g. by mechanically crushing) the ingots into a course powder, iv) refine the course powder (e.g. by milling) into a fine powder, and v) magnetically align and press the fine powder into a compact magnet, which may then undergo further processes until a specific microstructure is achieved. The combination of these energy intensive processes is slow, inefficient and costly.

### SUMMARY

According to a first aspect there is provided a method for recovering magnet material from a samarium cobalt, SmCo, magnet, the method comprising:
initiating a hydrogen decrepitation process within a reaction vessel, wherein the hydrogen decrepitation process comprises:
   increasing a concentration of hydrogen in the reaction vessel, and maintaining the reaction vessel at either: a temperature of less than 70° C. and at a pressure of more than 10 bar, or at a temperature of more than 70° C. and at a pressure of less than 5 bar, to cause hydrogen decrepitation of the SmCo magnet disposed in the reaction vessel and produce SmCo-hydride material; and
initiating a degasification process within a degasification vessel, wherein the degasification process comprises:
   removing gas from the degasification vessel and maintaining the degasification vessel at a temperature within a range of 150° C. to 300° C., to de-gas SmCo-hydride material disposed in the degasification vessel and produce SmCo material.

The SmCo may be referred to as SmₓCo_{y}. SmCo-hydride may be referred to as SmₓCo_{y}H_{z}. Subscripts x, y, and z may be any positive number. Subscript x may be equal to at least one of subscript y or subscript z. Similarly, subscript y may be equal to at least one of subscript z or subscript x.

At least one SmCo magnet may be disposed in the reaction vessel. For example, multiple SmCo magnets may be disposed in the reaction vessel. Accordingly, the method may permit magnet material to be recovered from multiple SmCo magnets simultaneously.

The degasification vessel may be the reaction vessel. In other words, the degasification process and the hydrogen decrepitation process may both occur in the same vessel, i.e., the reaction vessel.

The degasification process may comprise maintaining the degasification vessel at a temperature in a range of 260° C. to 300° C. The degasification process may comprise maintaining the degasification vessel at a temperature of 300° C.

The hydrogen decrepitation process may comprise maintaining the reaction vessel at a temperature within a range of 50° C. to 70° C., and at a pressure of 18 bar.

The hydrogen decrepitation process may comprise maintaining the reaction vessel at a temperature within a range of 100° C. to 150° C., and at a pressure of 2 bar.

The hydrogen decrepitation process may comprise maintaining the reaction vessel at a selected temperature and pressure for a predetermined length of time. For example, the hydrogen decrepitation process may comprise maintaining the reaction vessel at a selected temperature and pressure for 72 hours or less.

The method may further comprise, prior to initiating the hydrogen decrepitation process, determining if the magnet is magnetised, and if the magnet is magnetised, then demagnetising the magnet.

The method may further comprise, prior to initiating the hydrogen decrepitation process, determining if the SmCo magnet comprises a layer that at least partially reduces an ability of hydrogen to diffuse into the SmCo magnet, and if the SmCo magnet does comprise such a layer, then exposing at least one unlayered surface of the SmCo magnet to the environment. Exposing the at least one unlayered surface of the SmCo magnet to the environment may comprise at least one of removing at least a part of the layer that at least partially reduces an ability of hydrogen to diffuse into the magnet. Additionally or alternatively, exposing the at least one unlayered surface of the SmCo magnet to the environment may comprise fracturing the magnet.

The method may further comprise collecting hydrogen removed from the degasification vessel in the degasification process.

The method may further comprise, for at least a part of the hydrogen decrepitation process, agitating at least some of the materials contained within the reaction vessel.

The method may further comprise, prior to initiating the degasification process, machining the SmCo-hydride material into a powder. The SmCo-hydride material may be machined until the powder comprises a desired particle size distribution.

At least one of the SmCo material and the SmCo-hydride material may be mixed with a further substance.

The method may further comprise, prior to initiating the degasification process, magnetising the SmCo-hydride material. The magnetised SmCo-hydride material may be pressed into a SmCo-hydride compact. The SmCo-hydride compact may be degassed to produce a SmCo compact.

The method may further comprise magnetising the SmCo material. The magnetised SmCo material may be pressed into a SmCo compact.

The method may further comprise sintering the SmCo compact.

The method may further comprise homogenising the sintered SmCo compact. The homogenised SmCo compact may be further heat treated. The homogenised SmCo compact may be further heat treated until a desired microstructure is achieved. Further heat treatment steps may include at least one of isothermal aging, cooling (e.g. slow cooling), secondary aging, or quenching.

The SmCo magnet may be a Sm₂Co₁₇ magnet. The SmCo-hydride may comprise a stoichiometry of Sm₂Co₁₇H₅.

According to a second aspect there is provided an apparatus for recovering magnet material from a samarium cobalt, SmCo, magnet, the apparatus comprising:
at least one reaction vessel comprising at least one heating element, at least one sealable aperture, and at least one gas opening connectable to at least one of a hydrogen supply or a hydrogen store; and
at least one controller, wherein the at least one controller is configured to put the at least one reaction vessel in one of a hydrogen decrepitation setting or a degasification setting, wherein:
   the hydrogen decrepitation setting comprises increasing a concentration of hydrogen in the reaction vessel, and maintaining the reaction vessel at either: a temperature of less than 70° C. and at a pressure of more than 10 bar, or at a temperature of more than 70° C. and at a pressure of less than 5 bar; and
   the degasification setting comprises removing gas from the reaction vessel and maintaining the reaction vessel at a temperature within a range of 150° C. to 300° C.

### BRIEF DESCRIPTION OF THE DRAWINGS

Embodiments will now be described by way of example only with reference to the accompanying drawings, in which:

FIG. 1 shows a flowchart depicting a method for recovering magnet material from a samarium cobalt (SmCo) magnet according to a first example;

FIG. 2 shows a flowchart depicting a method for recovering magnet material from a SmCo magnet according to a second example;

FIG. 3 shows a schematic diagram of an apparatus for recovering magnet material from a SmCo magnet according to a first example;

FIG. 4 shows a schematic diagram of an apparatus for recovering magnet material from a SmCo magnet according to a second example; and

FIG. 5 shows a graph of pressure vs temperature from a degassing process applied to a SmCo magnet according to an example.

### DETAILED DESCRIPTION

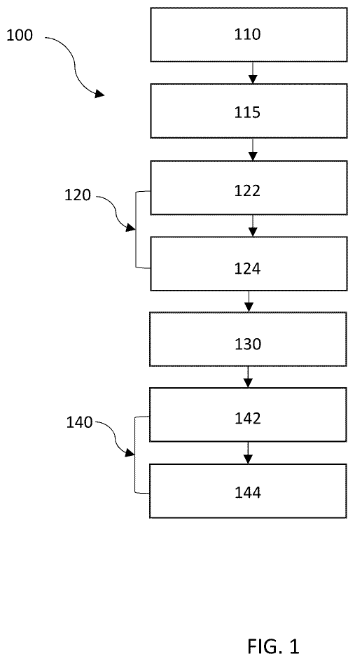

With reference to FIG. 1, the present disclosure relates to a method 100 for recovering magnet material from a samarium cobalt (SmCo) magnet according to a first example. The samarium cobalt magnet may be a Sm₂Co₁₇ magnet. The samarium cobalt magnet may however comprise any other stoichiometry, chemical formula, or ratio of samarium to cobalt. The samarium cobalt magnet may comprise a plurality of other transition metals. For example, the samarium cobalt magnet may further comprise at least one of iron (Fe), copper (Cu), or zirconium (Zr). The transition metals may be referred to as Feₘ, Cuₙ, and Zrᵥ. Subscripts m, n, and v may be any positive number. Subscript m may be equal to at least one of subscript n or subscript v. Similarly, subscript n may be equal to at least one of subscript v or subscript m. The magnet material recovered may be at least one of samarium, cobalt, or any of the other transition metals. For example, the magnet material recovered may include at least one of iron, copper, or zirconium. The magnet material recovered may be a compound comprising at least one of samarium or cobalt. The magnet material recovered may be SmCo. The magnet material recovered may be a compound comprising SmCo, e.g. a SmCo-hydride such as Sm₂Co₁₇H₅. The SmCo magnet may be, or have been, configured for use in a permanent magnet motor. Samarium cobalt may comprise a relatively high resistance to corrosion and temperature degradation, e.g. when compared to neodymium-based magnets. Accordingly, permanent magnet motors comprising samarium cobalt may be operable over a relatively wide temperature range with a relatively long life-expectancy. Therefore, samarium and cobalt are highly sought after, especially in relation to permanent magnet manufacture in aerospace applications. Supply chain challenges and price volatility associated with acquiring samarium and cobalt has created a demand for an efficient, effective, and environmentally friendly recovery process or method for recovering at least one of samarium cobalt, samarium, and cobalt from a magnet.

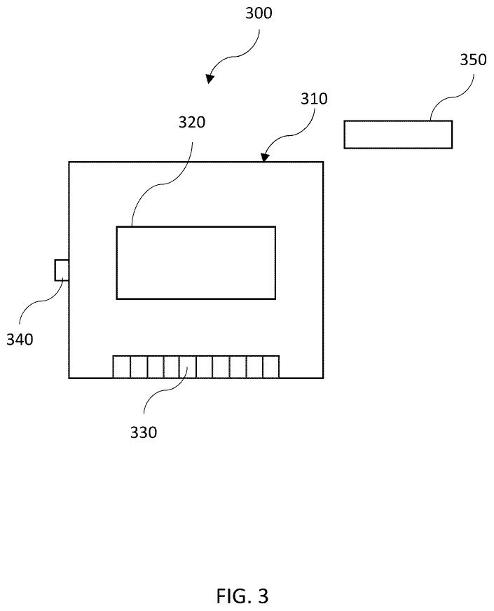

Referring still to FIG. 1, the method 100 for recovering magnet material from a SmCo magnet may comprise action 110 of disposing the SmCo magnet within a reaction vessel, such as reaction vessel 310 depicted in FIG. 3. It is noted that more than one SmCo magnet may be disposed within the reaction vessel. The SmCo magnet may be sealed within the reaction vessel. Accordingly, a user, e.g. a person, automated system, etc., may dispose the SmCo magnet within the reaction vessel and then seal the reaction vessel. For example, the user may open an aperture of the reaction vessel, dispose the magnet into the reaction vessel through the open aperture, and then close the aperture. Once closed, the aperture may form a seal, e.g. a gas-tight seal. Closing the aperture may prevent fluid, e.g. gas, from entering or exiting the reaction vessel through the aperture.

The method 100 for recovering magnet material from a SmCo magnet may comprise action 115 of initiating a hydrogen decrepitation process 120 within the reaction vessel. For example, the hydrogen decrepitation process 120 may be initiated once action 110 has been completed, i.e., once the SmCo magnet has been disposed within the reaction vessel. The hydrogen decrepitation process 120 may be configured to initiate automatically, e.g. the hydrogen decrepitation process 120 may initiate when a sensor or sensors determine that a SmCo magnet has been disposed within the reaction vessel. Additionally or alternatively, the hydrogen decrepitation process 120 may be manually initiated by a user. For example, a user may be able to initiate the hydrogen decrepitation process 120 on at least one of a controller, such as a remote controller, a switch, a control panel, etc.

The hydrogen decrepitation process 120 may comprise action 122 of increasing a concentration of hydrogen in the reaction vessel. The hydrogen decrepitation process 120 may comprise pumping or piping hydrogen from an external supply into the reaction vessel. For example, hydrogen stored in a hydrogen supply may be pumped or otherwise moved or directed from the hydrogen supply into the reaction vessel. Additionally or alternatively, hydrogen from a supply line may be pumped or otherwise moved or directed from the supply line into the reaction vessel. The concentration of hydrogen in the reaction vessel may be increased until a threshold hydrogen concentration limit or a threshold pressure limit is reached. For example, the reaction vessel may comprise at least one sensor configured to monitor a concentration of at least one of hydrogen and pressure in the reaction vessel. The at least one sensor may be configured to communicate, in a wireless or a wired manner, with at least one controller or alarm system. The at least one controller or alarm system may issue a warning, or otherwise alert a user, that a concentration of hydrogen within the reaction vessel or a pressure in the reaction vessel is within a range, e.g. a predetermined range, of at least one of the threshold hydrogen concentration limit and threshold pressure limit. When the concentration of hydrogen within the reaction vessel is within the range of the threshold hydrogen concentration limit, or when the concentration of hydrogen within the reaction vessel is equal (e.g. substantially or approximately equal) to the threshold hydrogen concentration limit, further hydrogen may be prevented from entering the reaction vessel. Additionally or alternatively, when the pressure within the reaction vessel is within the range of the threshold pressure limit, or when the pressure within the reaction vessel is equal (e.g. substantially or approximately equal) to the threshold pressure limit, further hydrogen may be prevented from entering the reaction vessel. For example, inlets to the reaction vessel may be closed, or hydrogen carrying piping may be disconnected or decoupled from the reaction vessel. Actions taken to prevent further hydrogen from entering the reaction vessel may be performed by a user or they may be performed automatically. For example, inlet(s) to the reaction vessel may automatically close when at least one of a concentration of hydrogen in the reaction vessel and a pressure of the reaction vessel is equal (e.g. substantially or approximately equal) to a predetermined limit.

It is noted that, for at least a part of the hydrogen decrepitation process 120, hydrogen may be prevented from leaving a chamber or cavity (of the reaction vessel) within which the SmCo magnet is configured to be disposed. In other words, hydrogen may be introduced into the reaction vessel and pressurised in the chamber or cavity within which the SmCo magnet is configured to be disposed. However, additionally or alternatively, hydrogen may be configured to flow over or around the SmCo magnet for at least a part of the hydrogen decrepitation process 120. For example, hydrogen may flow into the reaction vessel via an inlet, flow around or over the SmCo magnet, and then flow out of the reaction vessel via an outlet. Hydrogen flowing out of the reaction vessel may flow back into, e.g. be pumped or piped back into, the reaction vessel in a closed loop system. The hydrogen flow system may alternatively be an open loop system. Accordingly, hydrogen may be configured to continuously flow over or around the SmCo magnet for at least a part of the hydrogen decrepitation process 120.

The concentration of hydrogen in the reaction vessel may be maintained for the duration of the hydrogen decrepitation process 120. For example, the concentration of hydrogen in the reaction vessel may be maintained equal (e.g. substantially or approximately equal) to the threshold hydrogen concentration limit for the duration of the hydrogen decrepitation process 120. Additionally or alternatively, a concentration of hydrogen in the reaction vessel may be adjusted throughout the hydrogen decrepitation process 120. Such an adjustment may involve either increasing or decreasing a concentration of hydrogen in the reaction vessel. The adjustment may be manually initiated by a user, or automatically initiated by a controller.

As shown in FIG. 1, the hydrogen decrepitation process 120 may comprise action 124 of maintaining the reaction vessel at a temperature within a temperature range, and at a pressure within a pressure range. For example, during the hydrogen decrepitation process 120, a temperature within the reaction vessel may be maintained either i) at a temperature of less than 70° C. (e.g. approximately 70° C.) and at a pressure of more than 10 bar (e.g. approximately 10 bar), or ii) at a temperature of more than 70° C. (e.g. approximately 70° C.) and at a pressure of less than 5 bar (e.g. approximately 5 bar). If the temperature within the reaction vessel is maintained at a temperature of less than 70° C. (e.g. approximately 70° C.), then it may not be decreased to below 20° C. (e.g. approximately 20° C.). If the temperature within the reaction vessel is maintained at a temperature of more than 70° C. (e.g. approximately 70° C.), then it may not be increased to above 250° C. (e.g. approximately 250° C.). The reaction vessel may be maintained within these temperature and pressure ranges (i.e. ranges (i) or (ii) above) for a predetermined length of time. The predetermined length of time may be at least partly based on at least one of the selected temperature and pressure of the reaction vessel. For example, if the reaction vessel is maintained at a temperature equal (e.g. substantially or approximately equal) to 100° C., and a pressure equal (e.g. substantially or approximately equal) to 2 bar, then the predetermined length of time may be set to 72 hours. Similarly, if the reaction vessel is maintained at a temperature equal (e.g. substantially or approximately equal) to room temperature (approximately 20° C.) or 50° C., and a pressure equal (e.g. substantially or approximately equal) to 18 bar, then the predetermined length of time may be set to 72 hours. Alternatively, the reaction vessel may be maintained at a temperature within one of the above temperature ranges, and at a pressure within one of the above pressure ranges, for any length of time. For example, the reaction vessel may be maintained at a selected temperature and pressure until it is determined that the SmCo magnet has been sufficiently decrepitated by the hydrogen. A determination as to whether the SmCo magnet has been sufficiently decrepitated may be made by a user, e.g. a technician, or it may be made automatically, e.g. via at least one of camera(s), sensor(s), and controller(s) of the reaction vessel.

It is noted that during the hydrogen decrepitation process 120, hydrogen in the reaction vessel may diffuse into the SmCo magnet. The hydrogen that has diffused into the SmCo magnet may be absorbed into the material of the SmCo magnet by diffusion, e.g. diffusion along at least one of grain boundaries, dislocations, and sub-grain cellular structures of the SmCo magnet. This, in turn, may lead to the formation of a SmCo-hydride within the magnet. For example, if the SmCo magnet comprises Sm₂Co₁₇, then Sm₂Co₁₇H₅ may be formed within the magnet. The formation of a SmCo-hydride within the magnet may lead to an internal stress within the magnet, which may cause the magnet to fracture or decrepitate. For example, the magnet may fracture or decrepitate into SmCo-hydride material, or a mixture of SmCo material and SmCo-hydride material, or any other mixture of compounds comprising SmCo. The magnet may fracture or decrepitate into small pieces. For example, the magnet may fracture or decrepitate into a powder.

Increasing a temperature of the reaction vessel may increase the rate of hydrogen diffusion into the SmCo magnet. This may shorten a time required for the SmCo magnet to decrepitate. However, increasing a temperature of the reaction vessel beyond a temperature of 100° C. (e.g. approximately 100° C.) may cause an increase in an average size of the powder or material resulting from the hydrogen decrepitation process 120. This may be due to hydride-forming becoming less stable as temperatures are increased beyond a temperature of 100° C. (e.g. approximately 100° C.). Specifically, at a temperature of greater than 100° C. (e.g. approximately 100° C.), hydrogen decrepitation and de-gassing (further details of which are provided below) may occur simultaneously. This may reduce an achievable internal stress within the SmCo magnet, and thus prevent the SmCo magnet from fracturing or decrepitating into a powder with an appropriate, e.g. smaller, size distribution. A compromise may also be struck with the selected pressure within the reaction vessel. For example, increasing the pressure may reduce the time required for the SmCo magnet to decrepitate. Specifically, increasing the pressure may increase a hydrogen diffusion rate and associated hydride formation of the SmCo magnet. However, an increased pressure may also lead to a more expensive reaction vessel. It is noted that an appropriate size distribution (of material resulting from the hydrogen decrepitation of the SmCo magnet) may be considered a size distribution which minimises a need for further processing. At least one of the length of time over which the hydrogen decrepitation process 120 is configured to occur, the pressure of the reaction vessel, and the temperature of the reaction vessel, may be selected such as to enable the SmCo magnet to decrepitate into material or powder that requires less downstream processing. In particular, by applying a specific temperature and pressure, for a given time, the material or powder resulting from the hydrogen decrepitation process 120 may comprise a size distribution adequate to be directly used in the manufacture of another SmCo magnet. In other words, the material or powder resulting from the hydrogen decrepitation process 120 may not need to be milled before being used in the manufacture of another SmCo magnet. Specifically, an appropriate size distribution, along with an adequate energy consumption and safety criteria compliance, may be achieved from the hydrogen decrepitation process 120 when the temperature of the reaction vessel is no more than 70° C. (e.g. approximately 70° C.). For example, the reaction vessel may be maintained at room temperature, and the pressure may be maintained at no less than approximately 10 bar, e.g. 18 bar. Alternatively, an appropriate size distribution, along with an adequate energy consumption and safety criteria compliance, may be achieved from the hydrogen decrepitation process 120 when the temperature of the reaction vessel is no less than 70° C. (e.g. approximately 70° C.). For example, the reaction vessel may be maintained at 100° C., and the pressure may be maintained at no more than approximately 5 bar, e.g. 2 bar. In both cases, the SmCo magnet may decrepitate in 72 hours or less.

Although not shown, the hydrogen decrepitation process 120 may further comprise agitating at least some of the materials contained within the reaction vessel. For example, the reaction vessel may comprise a system configured to mechanically agitate at least one of the SmCo magnet, any SmCo material and SmCo-hydride material formed during the hydrogen decrepitation process 120. The reaction vessel may comprise any type of mechanical agitator, e.g. mixers, tumblers, drums, etc. Materials contained in the reaction vessel may be agitated continuously. For example, materials contained in the reaction vessel may be agitated throughout the entirety of the hydrogen decrepitation process. Alternatively, materials contained in the reaction vessel may be agitated intermittently. For example, materials contained in the reaction vessel may be agitated for a pre-determined length of time at pre-determined intervals, such as being agitated for 5 minutes every 2 hours. The length of time between intervals may not be equal. Similarly, the duration of the agitation at different intervals may not be equal. For example, materials within the reaction vessel may be agitated for 30 minutes after 5 hours, 45 minutes after 10 hours, and 1 hour after 10 hours. Agitation during the hydrogen decrepitation process may reduce a time required for the SmCo magnet to decrepitate. In addition, for a given temperature and pressure, a hydrogen decrepitation process that incorporates agitation may enable a smaller size distribution to be achieved, when compared to a hydrogen decrepitation process that does not incorporate agitation.

As is also depicted in FIG. 1, the method 100 for recovering magnet material from a SmCo magnet may comprise action 130 of initiating a degasification process 140. During the degasification process 140, hydrides may be broken down or decomposed, such that hydrogen may be removed from the magnet material. For example, during the degasification process 140, SmCo-hydride material may be broken down or decomposed into SmCo material and hydrogen. This ‘desorbed’ hydrogen may then be removed from the reaction vessel. In one example, the desorbed hydrogen may be pumped or otherwise moved into a store, such that it may be later used or recycled in another process. Alternatively, the desorbed hydrogen may be vented, burned, flared, or catalytically reacted.

The degasification process 140 may occur within the reaction vessel. In other words, both the degasification process 140 and the hydrogen decrepitation process 120 may occur within the same vessel. Alternatively, the degasification process 140 may occur in a vessel that is different to the reaction vessel which the hydrogen decrepitation process 120 occurs in. For example, the degasification process 140 may occur or be performed in a degasification vessel. However, it may be convenient for the degasification process 140 to occur in the same reaction vessel that the hydrogen decrepitation process 120 occurs in, as this may reduce a safety hazard associated with transporting SmCo-hydride material, and effectively enable hydrogen decrepitation and degassing to occur as a single two-step process within the same vessel.

Still referring to FIG. 1, the degasification process 140 may comprise action 142 of removing gas from the reaction vessel. For example, any surplus hydrogen left over from the hydrogen decrepitation process 120 may be removed. Additionally or alternatively, desorbed hydrogen formed during the degasification process 140 may be removed from the reaction vessel. Accordingly, the degasification process 140 may comprise pumping or otherwise moving gas, and in particular hydrogen, from the reaction vessel. The gas may be moved from the reaction vessel to any other type of vessel, store, container, etc. Gas may be removed from the reaction vessel intermittently. For example, a pump may pump gas out of the reaction vessel at predetermined intervals. Additionally or alternatively, a pump may pump gas out of the reaction vessel when at least one of a pressure of the reaction vessel and a concentration of hydrogen in the reaction vessel reaches a predetermined limit. Alternatively, gas may be continuously removed from the reaction vessel. For example, a pump may continuously pump gas out of the reaction vessel.

As is also shown in FIG. 1, the degasification process 140 may further comprise action 144 of maintaining the reaction vessel at a temperature within a range of 50° C. to 400° C., e.g. approximately 50° C. to approximately 400° C. Accordingly, the SmCo-hydride material (resulting from the hydrogen decrepitation process 120) may be degassed and SmCo material thereby produced. More specifically, the reaction vessel may be maintained at a temperature within a range of 150° C. to 300° C., e.g. approximately 150° C. to approximately 300° C., during the degasification process 140. During the degasification process 140, the reaction vessel may be maintained at any pressure. For example, the reaction vessel may be maintained at a pressure of 2 bar during the degasification process 140.

Accordingly, since the temperature range over which the hydrogen decrepitation process 120 may occur (e.g. approximately 20° C. to approximately 150° C.) is not too dissimilar from the temperature range over which the degasification process 140 may occur (e.g. approximately 150° C. to approximately 300° C.), it may be possible to use the same reaction vessel for both processes. Which, as mentioned above, may be more convenient and may improve a safety and effectiveness associated with recovering magnet material from a SmCo magnet.

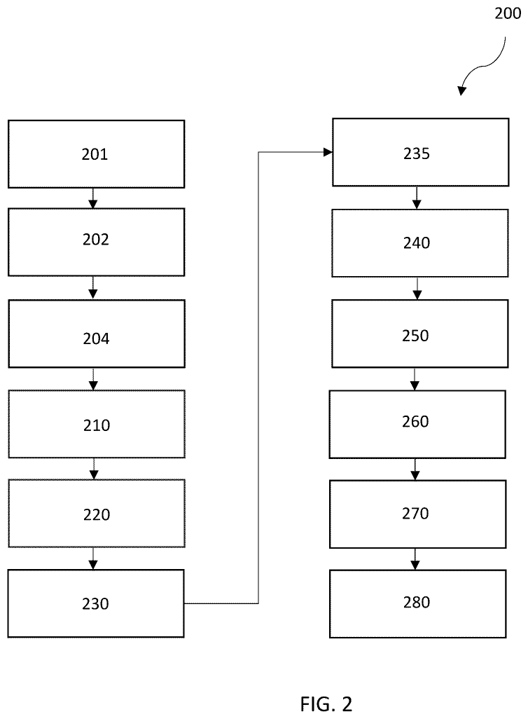

Referring now to FIG. 2, a method 200 for recovering magnet material from a SmCo magnet according to a second example is depicted. The method 200 may be considered a method for recovering and processing magnet material from a SmCo magnet. Any actions or features described in relation to method 100 may equally apply to method 200.

The method 200 for recovering magnet material from a SmCo magnet may comprise action 201 of determining a composition, stoichiometry, or microstructure of a magnet. Accordingly, it may be confirmed if the magnet is a SmCo magnet. Where the magnet is a SmCo magnet, the specific stoichiometry or microstructure of the SmCo magnet may be determined. For example, it may be determined if the SmCo magnet is a Sm₂Co₁₇ magnet. At least one of the selected temperature, the selected pressure and the selected length of time, used in the hydrogen decrepitation process 120, 220 or the degasification process 140, 240 may be at least partly based on the determined stoichiometry or microstructure of the SmCo magnet. The temperatures or pressures used in the hydrogen decrepitation/degasification processes may therefore be adjusted to suit different SmCo magnet stoichiometries or microstructures.

As shown in FIG. 2, method 200 may further comprise action 202 of determining whether the SmCo magnet is magnetised. It is noted that determining whether the SmCo magnet is magnetised may be done manually, e.g. by a technician etc. Additionally or alternatively, determining whether the SmCo magnet is magnetised may be done automatically, e.g. by an automated system or otherwise. For example, a system for determining a magnetism of an object may automatically determine whether the SmCo magnet is magnetised. If it is determined that the SmCo magnet is magnetised, then the SmCo magnet may be demagnetised. The SmCo magnet may be demagnetised thermally, e.g. by heating the SmCo magnet to a temperature equal to (e.g. approximately equal to) or greater than its Curie point. This may include heating the SmCo magnet to a temperature of at least ₈₅₀° C. Additionally or alternatively, the SmCo magnet may be demagnetised through the application of a reverse magnetic field. In other words, a reverse magnetic field may be applied to the SmCo magnet, to thereby demagnetise the SmCo magnet.

Method 200 may further comprise action 204 of determining if the SmCo magnet comprises at least one layer. The at least one layer may be at least partially disposed over a surface of the SmCo magnet. For example, the at least one layer may be any of a coating, an oxide, adhesive, etc. The at least one layer may be a layer that at least partially reduces an ability of hydrogen to diffuse into the SmCo magnet. In other words, the at least one layer may be a layer that may at least partially reduces a rate at which the SmCo magnet decrepitates under the effect of hydrogen. When it is determined that the SmCo magnet comprises such a layer, then it may be at least partially removed, e.g. by a technician, or automated system, so as to cause at least one surface of the SmCo magnet to be exposed to the surrounding environment. For example, the layer may be removed. Additionally or alternatively, the SmCo magnet may be fractured or cracked to at least partially expose a surface of the SmCo magnet. The surface of the SmCo magnet exposed may be ‘unlayered’. In other words, the surface of the SmCo magnet exposed may not comprise any of a coating, oxide, adhesive, etc. that at least partially reduces an ability of hydrogen to diffuse into the SmCo magnet. The at least one layer may be removed by way of grit blasting, machining, or any other suitable process. Additionally or alternatively, a ‘new’ or ‘other’ SmCo magnet surface may be formed by way of cracking, fracturing, or otherwise splitting the SmCo magnet.

Still referring to FIG. 2, method 200 may comprise action 210 of disposing the SmCo magnet in the reaction vessel (such as reaction vessel 310 shown in FIG. 3). Action 210 may comprise any of the actions or features described in relation to action 110 of method 100. It is noted that the order in which actions are shown to occur in FIG. 2 (e.g. action 210 occurring after actions 201, 202, and 204) are purely exemplary. The actions may occur in any order. Indeed, at least some of the actions described in relation to 201, 202, 204, may occur after the SmCo magnet is disposed in the reaction vessel. For example, the reaction vessel may comprise at least one of a sensor, controller, camera, etc. configured to determine a composition, stoichiometry, or microstructure of a magnet disposed within the reaction vessel to be determined (as described in relation to action 201 above). Additionally or alternatively, the reaction vessel may comprise at least one of a sensor, controller, camera, etc. configured to determine if the SmCo magnet is magnetised (as described in relation to action 202 above). The reaction vessel may further comprise any systems (e.g. heaters, magnetisers, etc.) to demagnetise a SmCo magnet. Additionally or alternatively, the reaction vessel may comprise at least one of a sensor, controller, camera, etc. configured to determine if the SmCo magnet comprises at least one layer (as described in relation to action 204 above). The reaction vessel may further comprise any systems (e.g. blasters, machining tools, shredders, etc.) to remove the at least one layer, or to otherwise at least partially expose a surface of the SmCo magnet. Accordingly, a technician, automated system, etc. may dispose the SmCo magnet in the reaction vessel, and at least some of the actions in relation to any of 201, 202, and 204 may be performed automatically.

Method 200 may comprise action 220 of effecting hydrogen decrepitation of a SmCo magnet disposed within the reaction vessel. Action 220 may comprise initiating a hydrogen decrepitation process within the reaction vessel. Accordingly, action 220 may comprise any of the actions or features described in relation to actions 115 and actions 120 of method 100.

As shown in FIG. 2, method 200 may comprise action 230 of further processing, e.g. machining, at least one of SmCo-hydride material and SmCo material into a powder. Specifically, SmCo-hydride material formed in the hydrogen decrepitation process 220 may be machined into a powder. Action 230 may be implemented when a desired size distribution of material or powder (such as for magnet reprocessing) is difficult to achieve solely through hydrogen decrepitation. The SmCo-hydride material may be machined until the material or powder comprises the desired particle size distribution. Machining may include crushing. Additionally or alternatively, machining may include milling, grinding, laser cutting, drilling, etc. The SmCo-hydride material may be machined in the reaction vessel. Alternatively, the SmCo-hydride material may be machined remote to the reaction vessel, such as in a different vessel. The SmCo-hydride material may be flammable. Accordingly, it may be machined in an inert environment. SmCo-hydride material may be brittle compared to SmCo material. Therefore, SmCo-hydride material may be more readily machined into a powder or material comprising the desired particle size distribution than SmCo material. Thus, action 230 may occur prior to degassing process 240. Alternatively, action 230 may occur after the degassing process 240. In other words, SmCo material produced from the degassing process 240 may be further processed, e.g. machined, into a powder comprising the desired particle size distribution. This may be the case when it is difficult to transport or provide an inert environment for the SmCo-hydride material to be further processed, e.g. machined, in.

Method 200 may further comprise action 235 of mixing the SmCo-hydride material (resulting from the hydrogen decrepitation process 220) with a further substance. Additionally or alternatively, action 235 may occur after degasification process 240. In other words, action 235 may comprise mixing SmCo material (resulting from degasification process 240) with a further substance. Mixing may include blending. The further substance may be a ‘virgin’ powder or material. Virgin powder/material may comprise powder/material that has not been reclaimed or recovered through a recycling process. The virgin powder/material may comprise at least one of samarium, cobalt, and samarium cobalt. Additionally or alternatively, the further substance may comprise at least one of further SmCo material and further SmCo-hydride material. Such further SmCo material or further SmCo-hydride material may have been produced in another hydrogen decrepitation process or another degasification process. Additionally or alternatively, the further substance may be a feedstock comprising any mixture of elements or compounds. Mixing at least one of the SmCo material and the SmCo-hydride material with a further substance may allow for compositional correction, e.g. to account for any loss of elements, compounds, or materials during the hydrogen decrepitation process 220. Accordingly, the mixed powder may comprise desired properties, such as desired magnetic properties. For example, at least one of the SmCo material and the SmCo-hydride material may be mixed with a further substance until the resulting mixed powder has a desired magnetic field strength.

Method 200 may comprise action 240 of degassing SmCo-hydride material produced in the hydrogen decrepitation process 220. Action 240 may comprise initiating the degasification process within the reaction vessel. Accordingly, action 240 may comprise any of the actions or features described in relation to actions 130 and actions 140 of method 100.

Referring still to FIG. 2, method 200 may comprise processing SmCo material into a SmCo compact. For example, method 200 may comprise processing the SmCo material produced in the degasification process 240 into a SmCo compact. Where the SmCo material has been mixed with a further substance, then the resulting mixture may be processed into a SmCo compact. Such a process may comprise action 250 of magnetising SmCo material. The SmCo material may be magnetised using any method, e.g. with an external magnetic field. In action 260, the magnetised SmCo material may be pressed into a SmCo compact. Although actions 250 and 260 may occur after the degasification process 240, it is also contemplated that actions 250 and 260 may occur prior to the degasification process 240. Accordingly, actions 250 and 260 may comprise magnetising SmCo-hydride material (produced in the hydrogen decrepitation process 220), pressing the magnetised SmCo-hydride material into a compact, and then degasifying the SmCo-hydride compact to produce a SmCo compact. In action 270, the SmCo compact may be sintered, e.g. in a furnace. In action 280, the sintered SmCo compact may be further heat treated. For example, the sintered SmCo compact may be homogenised or solutionised and then cooled. Specifically, the SmCo compact may be quenched after being homogenised. Further heat treatment steps may be applied to the quenched SmCo compact, including at least one of isothermal aging, cooling, and secondary aging, until a desired magnet microstructure is achieved.

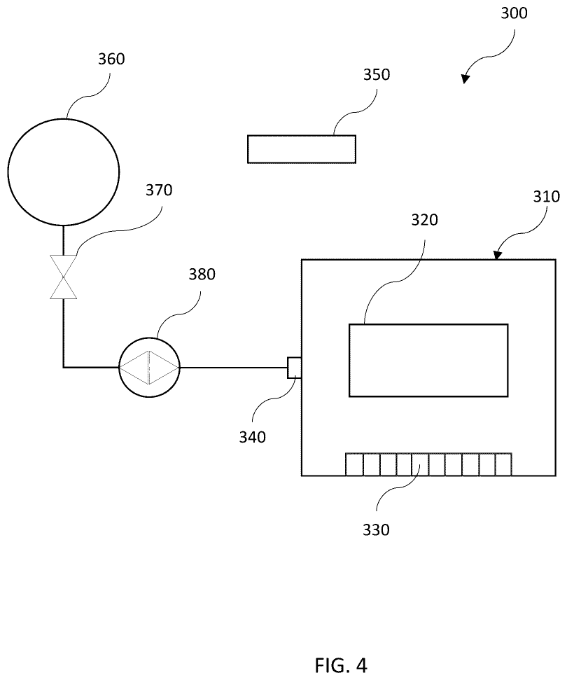

Referring now to FIG. 3, the present disclosure relates to an apparatus 300 for recovering magnet material from a samarium cobalt, SmCo, magnet. The apparatus 300 may comprise at least one reaction vessel 310. Although not shown, the apparatus 300 may comprise a first vessel and a second vessel. The first vessel may be configured to perform hydrogen decrepitation. The second vessel may be configured to perform degasification. Alternatively, and as shown in FIGS. 3 and 4, the apparatus 300 may comprise one reaction vessel 310 configured to perform either hydrogen decrepitation or degasification. In other words, the apparatus 300 may comprise one reaction vessel able to perform both hydrogen decrepitation and degasification.

The SmCo magnet may be disposed inside reaction vessel 310. In other words, the reaction vessel 310 may be configured to receive the SmCo magnet. It is noted that a reaction vessel (e.g. reaction vessel 310) may be configured to receive more than one SmCo magnet. Reaction vessel 310 may comprise a cavity or void. The SmCo magnet may be disposed or received within the cavity or void of the reaction vessel 310. The reaction vessel 310 may comprise at least one aperture 320. The aperture 320 may be sealable. When open, the aperture 320 may enable parts, items, materials, systems, apparatus, etc., such as a SmCo magnet, to be retrieved, placed, or disposed inside the reaction vessel 310. When closed, the aperture 320 may form a gas-tight seal. The reaction vessel 310 may further comprise at least one heating element 330. The heating element 330 may be an electric heater, gas heater, etc. The reaction vessel 310 may comprise any number and type of sensors, cameras, controllers, etc. For example, the reaction vessel 310 may comprise sensors to determine one or more parameters, such as pressure(s) within the reaction vessel 310, temperature(s) within the reaction vessel 310, a concentration of hydrogen within the reaction vessel 310, an extent of decrepitation of the SmCo magnet, an extent of degasification of SmCo-hydride material within the reaction vessel 310, if the aperture 320 is open or closed, etc.

The reaction vessel 310 may further comprise at least one gas opening 340. The gas opening 340 may be sealable. That is, when closed, the gas-opening may form a gas-tight seal. When open, the gas opening 340 may be configured to allow gas to flow in or out of the reaction vessel 310. In one example, a pipe or duct may connect the gas opening 340 to a hydrogen supply. The hydrogen supply may comprise a store of hydrogen, such as a tank comprising hydrogen. Additionally or alternatively, the hydrogen supply may be a hydrogen supply line. Hydrogen may thus flow from the hydrogen supply and into the reaction vessel 310. Specifically, hydrogen may flow from the hydrogen supply, through the gas opening 340, and into the reaction vessel 310. The gas opening 340 may be configured to automatically seal or be manually sealed. The gas opening 340 may be configured to seal when at least one of a pressure and a concentration of hydrogen in the reaction vessel 310 reached, or is within a range, of a predetermined threshold limit. During a degasification process, the gas opening 340 may be configured to stay open, e.g. be in an unsealed configuration, such that gas may flow out of the reaction vessel 310. During the degasification process, a vessel, store, etc. may be connected or coupled to the gas opening 340, such that gas may flow out of the reaction vessel 310 and into the connected or coupled vessel, store, etc. The hydrogen collected in the connected or coupled vessel or store may subsequently be used in another process.

Although not shown, the at least one gas opening 340 may comprise at least one inlet and at least one outlet. At least one of the inlet and outlet may be sealable. When open, the inlet may be configured to permit gas, and in particular hydrogen, to flow into the reaction vessel 310. The outlet may be configured to be sealed, e.g. closed or shut, when the inlet is open. Similarly, the inlet may be configured to be sealed, e.g. closed or shut, when the outlet is open. Accordingly, during a hydrogen decrepitation process, the inlet may open to permit hydrogen gas into the reaction vessel 310. The outlet may be sealed such that hydrogen cannot flow out from the reaction vessel 310. Once a concentration of hydrogen or pressure within the reaction vessel 310 is equal (e.g. substantially or approximately equal) to a threshold limit, the inlet may be sealed. Similarly, when a degasification process is initiated, at least one of the outlet and inlet may be opened. A store, vessel, container, etc. may be connected or coupled to at least one of the inlet and outlet, such that gas, and in particular hydrogen, flowing out from the reaction vessel 310 may be safely stored.

It is noted that a piping or duct system may connect the inlet of the reaction vessel 310 to the outlet of the reaction vessel 310. If, for example, it is desired to have a continuous flow of hydrogen through the at least one reaction vessel 310 during a hydrogen decrepitation process, then a piping or duct system may fluidically couple the inlet to the outlet. Accordingly, hydrogen may flow into the reaction vessel 310 by the inlet of the reaction vessel 310, flow over and around a SmCo magnet disposed in the reaction vessel 310, out of the outlet of the reaction vessel 310, and back around to the inlet of the reaction vessel 310 to start the cycle again. The piping or duct system connecting the inlet to the outlet may comprise a flow pump. The flow pump may be configured to pump gas, and in particular hydrogen, around the piping or duct system connecting or coupling the inlet of the reaction vessel 310 to the outlet of the reaction vessel 310.

Referring still to FIG. 3, the apparatus 300 may comprise at least one controller 350. Controller 350 may be remote to the reaction vessel 310. For example, controller 350 may be implemented on a device such as a mobile phone, laptop, etc. Additionally or alternatively, the controller may be implemented as a control panel disposed on or proximate to the reaction vessel 310. Additionally or alternatively, controller 350 may comprise at least one switch disposed on, proximate to, or remote to the reaction vessel 310. For example, the controller 350 may comprise at least one analogue switch or at least one digital switch. It is noted that there may be multiple controllers of different types. For example, the apparatus 300 may comprise a remote controller and a controller disposed on or proximate to the reaction vessel 310. It is further noted that one controller may control multiple reaction vessels. Additionally or alternatively, each reaction vessel may have a corresponding controller.

Controller 350 may enable a user, e.g. a technician, to put the reaction vessel 310 in either a hydrogen decrepitation setting or a degasification setting. Controller 350 may enable a user, e.g. a technician, to control the reaction vessel 310 between at least one of a hydrogen decrepitation setting and a degasification setting.

In a first example, a user may select, on the controller, the hydrogen decrepitation setting. Selecting the hydrogen decrepitation setting may comprise increasing a concentration of hydrogen in the reaction vessel 310, and maintaining the reaction vessel 310 at a temperature within a range of 50° C. to 150° C. (e.g. approximately 50° C. to approximately 150° C.) and at a pressure within a range of 2 bar to 18 bar (e.g. approximately 2 bar to approximately 18 bar). For example, selecting the hydrogen decrepitation setting may comprise maintaining the reaction vessel at either a temperature of less than 70° C. (e.g. approximately 70° C.) and at a pressure of more than 10 bar (e.g. approximately 10 bar), or at a temperature of more than 70° C. (e.g. approximately 70° C.) and at a pressure of less than 5 bar (e.g. approximately 5 bar). This may cause hydrogen decrepitation of a SmCo magnet disposed in the reaction vessel 310.

Selecting the hydrogen decrepitation setting may cause hydrogen to flow from a hydrogen supply into the reaction vessel 310. For example, selecting the hydrogen decrepitation setting may cause the gas opening 340 to open. Accordingly, hydrogen may flow from a hydrogen store, through the gas opening 340, and into the reaction vessel 310.

As shown in FIG. 4, the apparatus 300 may further comprise at least one of a hydrogen store 360, a valve 370, and a process pump 380. The apparatus may further comprise ducting or piping that fluidically couples the hydrogen store 360, valve 370, or process pump 380 to the reaction vessel 310. Selecting the hydrogen decrepitation setting may cause the valve 370 to open, turn the process pump 380 on, and open the gas opening 340. Hydrogen stored in the hydrogen store 360 may thus flow towards the process pump 380, and be pumped through the gas opening 340 into the reaction vessel 310. Hydrogen may be pumped into the reaction vessel 310 until a pressure within the reaction vessel 310 is within a range of 2 bar to 18 bar (e.g. approximately 2 bar to approximately 18 bar). Once the pressure reaches a predetermined limit or threshold, the gas opening may be sealed, to thereby prevent any further hydrogen from entering the reaction vessel 310 and prevent any hydrogen in the reaction vessel 310 from leaving, exiting, or otherwise escaping the reaction vessel 310.

Selecting the hydrogen decrepitation setting may further cause the heating element 330 to switch on. In particular, the heating element 330 may be configured to heat the reaction vessel 310 to a temperature within a range of 50° C. to 150° C. (e.g. approximately 50° C. to approximately 150° C.). The heating element 330 may be controlled by the controller 350 throughout the duration of the hydrogen decrepitation process. Accordingly, a user may adjust, e.g. increase or decrease, a temperature of the reaction vessel 310 during the hydrogen decrepitation process.

In a second example, a user may select, on the controller, the degasification setting. It is noted that, where the reaction vessel 310 comprises a reaction vessel configured to perform both hydrogen decrepitation and degasification, the degasification process may be configured to automatically initiate or start once the hydrogen decrepitation has ended in that reaction vessel. For example, a user may select, on the controller 350, a third setting. The third setting may comprise initiating the hydrogen decrepitation process within the reaction vessel 310, and once the hydrogen decrepitation process has finished or otherwise completed, automatically initiating the degasification process within the reaction vessel 310.

Selecting the degasification setting may comprise removing gas from the reaction vessel 310 and maintaining the reaction vessel 310 at a temperature within a range of 50° C. to 400° C. (e.g. approximately 50° C. to approximately 400° C.). Specifically, the reaction vessel may be maintained at a temperature within a range of 150° C. to 300° C. (e.g. approximately 150° C. to approximately 300° C.). SmCo-hydride material in the reaction vessel 310 may therefore be degassed, and SmCo material may thereby be produced.

Selecting the degasification setting may cause hydrogen to flow out from, or be removed from, the reaction vessel 310. Specifically, hydrogen may flow from the reaction vessel 310 and into a hydrogen store, vessel, container, etc. For example, selecting the degasification setting may cause the gas opening 340 to open. Accordingly, hydrogen may flow out from the reaction vessel 310, through the gas opening 340, and into a hydrogen store, container, etc. It is noted that the hydrogen store used in the degasification process may be the same hydrogen store that was used as a supply of hydrogen in the hydrogen decrepitation process. In other words, hydrogen store 360 may supply hydrogen to the reaction vessel 310 during the hydrogen decrepitation process, and may receive hydrogen from the reaction vessel 310 during the degasification process. Alternatively, a further hydrogen store, vessel, container, tank, etc. that is different to the hydrogen store 360 used in the hydrogen decrepitation process may be coupled or connected to the reaction vessel 310 for the degasification process. Referring to FIG. 4, selecting the degasification setting may cause the valve 370 to open, turn the process pump 380 on, and open the gas opening 340. Process pump 380 may be a two-way or reversible pump. In other words, process pump 380 may be configured to pump fluid, e.g. gas, in a first direction in the hydrogen decrepitation process, and in a second direction in the degasification process. Additionally or alternatively, apparatus 300 may comprise a further process pump 380. The further process pump may be configured to switch on in the degasification process. Process pump 380 may therefore be configured to switch on in the hydrogen decrepitation process, whilst the further process pump may be configured to switch on in the degasification process. Hydrogen may thus flow out from the reaction vessel 310 through the gas opening 340, towards at least one of the process pump 380 and the further process pump, and be pumped into the hydrogen store 360 or a further hydrogen store.

Selecting the degasification setting may further cause the heating element 330 to switch on. Alternatively, if the heating element 330 is already switched on, e.g. from the hydrogen decrepitation process, then selecting the degasification setting may cause the heating element 330 to either heat up or cool down, i.e. either increase or decrease in temperature. In particular, the heating element 330 may be configured to heat the reaction vessel 310 to a temperature within a range of 50° C. to 400° C. (e.g. approximately 50° C. to approximately 400° C.) in the degasification setting. More specifically, the heating element 330 may be configured to heat the reaction vessel 310 to a temperature within a range of 150° C. to 300° C. (e.g. approximately 150° C. to approximately 300° C.) in the degasification setting. The heating element 330 may be controlled by the controller 350 throughout the duration of the degasification process. Accordingly, a user may adjust, e.g. increase or decrease, a temperature of the reaction vessel 310 during the degasification process.

It is noted that the controller 350, shown in FIG. 3 and FIG. 4, may enable a user to adjust at least one of a temperature, pressure, and length of time of at least one of a hydrogen decrepitation process and a degasification process. It is envisioned that a hydrogen decrepitation process may last for no more than 72 hours. However, a user may set a length of time for the hydrogen decrepitation process to be greater than, or less than, 72 hours. The controller 350 may further be used to shut-down the reaction vessel 310, or to terminate a hydrogen decrepitation process or a degasification process prematurely.

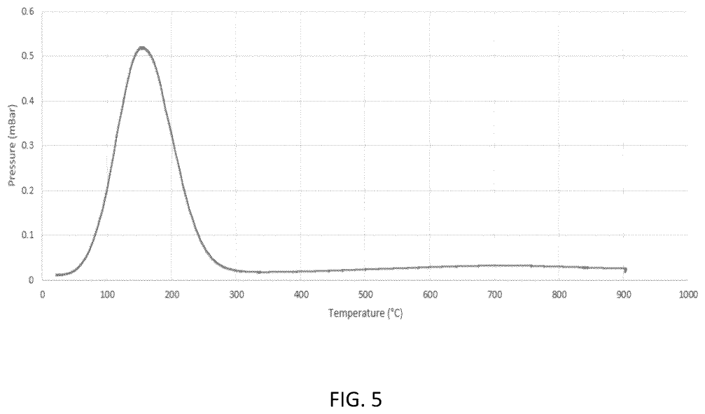

Referring now to FIG. 5, which shows a graph of pressure vs temperature from a degassing process applied to a SmCo-hydride. The pressure indicates the pressure in the vessel and is representative of the amount of hydrogen that has been desorbed at a given temperature. It can be observed that the peak hydrogen desorption occurs in a temperature range of 150° C. to 300° C. (e.g. approximately 150° C. to approximately 300° C.). It can be further observed that the maximum degassing occurs at a temperature of approximately 160° C. It can also be observed that the degassing peak ends, or otherwise levels off, in the range of 260° C. to 300° C. Such a levelling off of the degassing peak indicates that a significant proportion of the hydride in the SmCo-hydride has been desorbed. Such a levelling off of the degassing peak thus indicates that a temperature in a range of 260° C. to 300° C. 300 C may liberate at least a significant proportion of hydrogen from SmCo-hydride. Accordingly, the degasification process may comprise maintaining the reaction vessel 310 at 260° C., 300° C., or otherwise in a range of 260° C. to 300° C. (e.g. approximately 260° C. to approximately 300° C.). This value is surprising given the much higher temperature ranges that are typically used to degas SmCo-hydride. The method and apparatus may thus improve an efficiency, e.g. an energy efficiency, associated with recovering magnet material from a samarium cobalt magnet. Further, since degassing occurs in a temperature range of 150° C. to 300° C. (e.g. approximately 150° C. to approximately 300° C.), which is not too dissimilar to the temperature ranges of the hydrogen decrepitation process, there is good opportunity to perform a single two-step hydrogen decrepitation and degassing process using the same reaction vessel. This may improve the speed and effectiveness associated with recovering magnet material from a samarium cobalt magnet, particularly as flammable SmCo-hydride material may be degassed in-situ, i.e., it may not be required to move or transport the SmCo-hydride material out of the controllable environment of the reaction vessel 310.

Various examples have been described, each of which comprise one or more combinations of features. It will be appreciated by those skilled in the art that, except where clearly mutually exclusive, any of the features may be employed separately or in combination with any other features and the invention extends to and includes all combinations and sub-combinations of one or more features described herein.

We claim:

1. A method for recovering magnet material from a samarium cobalt, SmCo, magnet, the method comprising:
initiating a hydrogen decrepitation process within a reaction vessel, wherein the hydrogen decrepitation process comprises:
increasing a concentration of hydrogen in the reaction vessel, and maintaining the reaction vessel at either: a temperature of less than 70° C. and at a pressure of more than 10 bar, or at a temperature of more than 70° C. and at a pressure of less than 5 bar, to cause hydrogen decrepitation of the SmCo magnet disposed in the reaction vessel and produce SmCo-hydride material; and
initiating a degasification process within a degasification vessel, wherein the degasification process comprises:
removing gas from the degasification vessel and maintaining the degasification vessel at a temperature within a range of 150° C. to 300° C., to de-gas SmCo-hydride material disposed in the degasification vessel and produce SmCo material.

2. The method of claim 1, wherein the degasification vessel is the reaction vessel.

3. The method of claim 1, wherein the degasification process comprises maintaining the degasification vessel at a temperature of 300° C.

4. The method of claim 1, wherein the hydrogen decrepitation process comprises maintaining the reaction vessel at a temperature within a range of 50° C. to 70° C., and at a pressure of 18 bar.

5. The method of claim 1, wherein the hydrogen decrepitation process comprises maintaining the reaction vessel at a temperature within a range of 100° C. to 150° C., and at a pressure of 2 bar.

6. The method of claim 1, wherein the hydrogen decrepitation process comprises maintaining the reaction vessel at a selected temperature and pressure for a predetermined length of time.

7. The method of claim 1, further comprising, prior to initiating the hydrogen decrepitation process, determining if the magnet is magnetised, and if the magnet is magnetised, then demagnetising the magnet.

8. The method of claim 1, further comprising, prior to initiating the hydrogen decrepitation process, determining if the SmCo magnet comprises a layer that at least partially reduces an ability of hydrogen to diffuse into the SmCo magnet, and if the SmCo magnet does comprise such a layer, then exposing at least one unlayered surface of the SmCo magnet to the environment.

9. The method of claim 8, wherein exposing the at least one unlayered surface of the SmCo magnet to the environment comprises at least one of removing at least a part of the layer that at least partially reduces an ability of hydrogen to diffuse into the magnet, or fracturing the magnet.

10. The method of claim 1, further comprising collecting hydrogen removed from the degasification vessel in the degasification process.

11. The method of claim 1, further comprising, for at least a part of the hydrogen decrepitation process, agitating at least some of the materials contained within the reaction vessel.

12. The method of claim 1, further comprising, prior to initiating the degasification process, machining the SmCo-hydride material into a powder.

13. The method of claim 12, wherein the SmCo-hydride material is machined until the powder comprises a desired particle size distribution.

14. The method of claim 1, wherein at least one of the SmCo material and the SmCo-hydride material is mixed with a further substance.

15. The method of claim 1, further comprising, prior to initiating the degasification process, magnetising the SmCo-hydride material and pressing the magnetised SmCo-hydride material into a SmCo-hydride compact, the SmCo-hydride compact then being degassed to produce a SmCo compact.

16. The method of claim 1, further comprising magnetising the SmCo material and pressing the magnetised SmCo material into a SmCo compact.

17. The method of claim 15, further comprising sintering the SmCo compact.

18. The method of claim 17, further comprising homogenising the sintered SmCo compact and then further heat treating the homogenised SmCo compact until a desired microstructure is achieved.

19. The method of claim 1, wherein the SmCo magnet is a Sm₂Co₁₇ magnet, and wherein the SmCo-hydride comprises a stoichiometry of Sm₂Co₁₇H₅.

20. Apparatus for recovering magnet material from a samarium cobalt, SmCo, magnet, the apparatus comprising:
at least one reaction vessel comprising at least one heating element, at least one sealable aperture, and at least one gas opening connectable to at least one of a hydrogen supply or a hydrogen store; and
at least one controller, wherein the at least one controller is configured to put the at least one reaction vessel in one of a hydrogen decrepitation setting or a degasification setting, wherein:
the hydrogen decrepitation setting comprises increasing a concentration of hydrogen in the reaction vessel, and maintaining the reaction vessel at either: a temperature of less than 70° C. and at a pressure of more than 10 bar, or at a temperature of more than 70° C. and at a pressure of less than 5 bar; and
the degasification setting comprises removing gas from the reaction vessel and maintaining the reaction vessel at a temperature within a range of 150° C. to 300° C.
